(19) United States
(12) Patent Application Publication
(10) Pub. No.: US 2024/0051386 A1
(43) Pub. Date: Feb. 15, 2024

(54) MOTOR DISCONNECT CONTROLS FOR ALL WHEEL DRIVE BATTERY ELECTRIC VEHICLE

(71) Applicant: GM Global Technology Operations LLC, Detroit, MI (US)

(72) Inventors: Dongxu Li, Troy, MI (US); Edward W. Mellet, Rochester Hills, MI (US); Norman K. Bucknor, Troy, MI (US); Clinton E. Carey, Highland, MI (US); Thomas W. Nehl, Shelby Township, MI (US)

(21) Appl. No.: 17/884,029

(22) Filed: Aug. 9, 2022

(51) Int. Cl. B60K 17/346; B60K 23/08

(52) U.S. Cl. CPC B60K 17/3462; B60K 23/0808; B60Y 2200/91

(57) ABSTRACT

An electric vehicle, system, and method for operating the vehicle. The electric vehicle has a first motor, a second motor and a processor. The processor is configured to select the first motor for disengagement from a first axle, adjust a torque provided from the first motor to the first axle to zero, disengage the first motor from the first axle, and reduce a speed of the first motor to zero.

### INTRODUCTION

The subject disclosure relates to electric vehicles and, in particular, to a system and method for improving a range of an electric vehicle by managing an engagement and disengagement of a motor to an axle of the electric vehicle.

A heavy duty or medium duty electric vehicle can employ multiple motors drawing from one or more battery sources to provide a torque suitable for propelling the electric vehicle. During heavy duty use, such as in an all-wheel drive scenario, some or all of the motors can be employed. During less strenuous use, such as in daily driving, fewer motors or a single motor are needed. Use of a motor when not needed draws power unnecessarily from the one or more battery sources, thereby draining the one or more battery sources and reducing the range of the vehicle. Accordingly, it is desirable to provides a system and method for managing the multiple motors as appropriate to suit the particular torque requirements of a drive scenario.

### SUMMARY

In one exemplary embodiment, a method for operating a battery electric vehicle having a first motor and a second motor is disclosed. A first motor is selected for disengagement from a first axle. A torque provided from the first motor to the first axle is adjusted to zero. The first motor is disengaged from the first axle. A speed of the first motor is reduced to zero.

In addition to one or more of the features described herein, adjusting the torque from the first motor further includes transferring a torque load of the first motor to at least the second motor. The method further includes identifying an engagement clutch associated with the first motor from a gear state associated with the first motor and disengaging the engagement clutch. The method further includes selecting to engage the first motor to the first axle, determining the speed of the first motor, synchronizing a clutch speed of a clutch with the speed of the first motor, and engaging the clutch to connect the first motor to the first axle. Synchronizing the clutch speed further includes at least one of controlling a rotation of the first motor to a selected motor speed and controlling a transfer torque of the clutch to rotate the first motor to the selected motor speed. The method further includes synchronizing the clutch speed to a selected motor speed by controlling at least one of the first motor and the clutch during regenerative braking at the first motor. Reducing the speed of the first motor to zero recovers rotational energy.

In another exemplary embodiment, a system for operating an electric vehicle having a first motor and a second motor is disclosed. The system includes a processor configured to select the first motor for disengagement from a first axle, adjust a torque provided from the first motor to the first axle to zero, disengage the first motor from the first axle, and reduce a speed of the first motor to zero.

In addition to one or more of the features described herein, the processor is further configured to adjust the torque from the first motor to zero by transferring a torque load of the first motor to at least the second motor. The processor is further configured to identify an engagement clutch associated with the first motor from a gear state associated with the first motor and disengage the engagement clutch. The processor is further configured to select the first motor for engagement to the first axle, determine the speed of the first motor, synchronize a clutch speed of a clutch with the speed of the first motor, and engage the clutch to connect the first motor to the first axle. Synchronizing the clutch speed further includes at least one of controlling a rotation of the first motor to a selected motor speed and controlling a transfer torque of the clutch to rotate the first motor to the selected motor speed. The processor is further configured to synchronize the clutch speed to an axle speed by controlling at least one of the first motor and the clutch during regenerative braking at the first motor. Reducing the speed of the first motor to zero recovers rotational energy.

In yet another exemplary embodiment, an electric vehicle is disclosed. The electric vehicle includes a first motor, a second motor, and a processor. The processor is configured to select the first motor for disengagement from a first axle, adjust a torque provided from the first motor to the first axle to zero, disengage the first motor from the first axle, and reduce a speed of the first motor to zero.

In addition to one or more of the features described herein, the processor is further configured to adjust the torque from the first motor to zero by transferring a torque load of the first motor to at least the second motor. The processor is further configured to identify an engagement clutch associated with the first motor from a gear state associated with the first motor and disengaging the engagement clutch. The processor is further configured to select to engage the first motor to the first axle, determine the speed of the first motor, synchronize a clutch speed of a clutch with the speed of the first motor, and engage the clutch to connect the first motor to the first axle. Synchronizing the clutch speed further includes at least one of controlling a rotation of the first motor to a selected motor speed and controlling a transfer torque of the clutch to rotate the first motor to the selected motor speed. The processor is further configured to synchronize the clutch speed to an axle speed by controlling at least one of the first motor and the clutch during regenerative braking at the first motor.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 shows a schematic diagram of an electric vehicle in a plan view;

FIG. 2 shows a schematic view of a drive system of the electric vehicle in an embodiment;

FIG. 3 is a diagram illustrating speed relations between the various components of the drive system;

FIG. 4 is a diagram illustrating speed relations in a scenario in which the vehicle is moving with an output speed that is positive and the motor is turned off;

FIG. 5 is a diagram illustrating operation of a controller of the electric vehicle, in an embodiment;

FIG. 6 shows a flowchart of a method for disengaging a motor from an axle;

FIG. 7 shows a flowchart of a method for engaging a disengaged motor to an axle; and

FIG. 8 shows a graph illustrating torque distributions between the first motor and the second motor using the methods disclosed herein.

### DETAILED DESCRIPTION

The following description is merely exemplary in nature and is not intended to limit the present disclosure, its application or uses. It should be understood that throughout the drawings, corresponding reference numerals indicate like or corresponding parts and features.

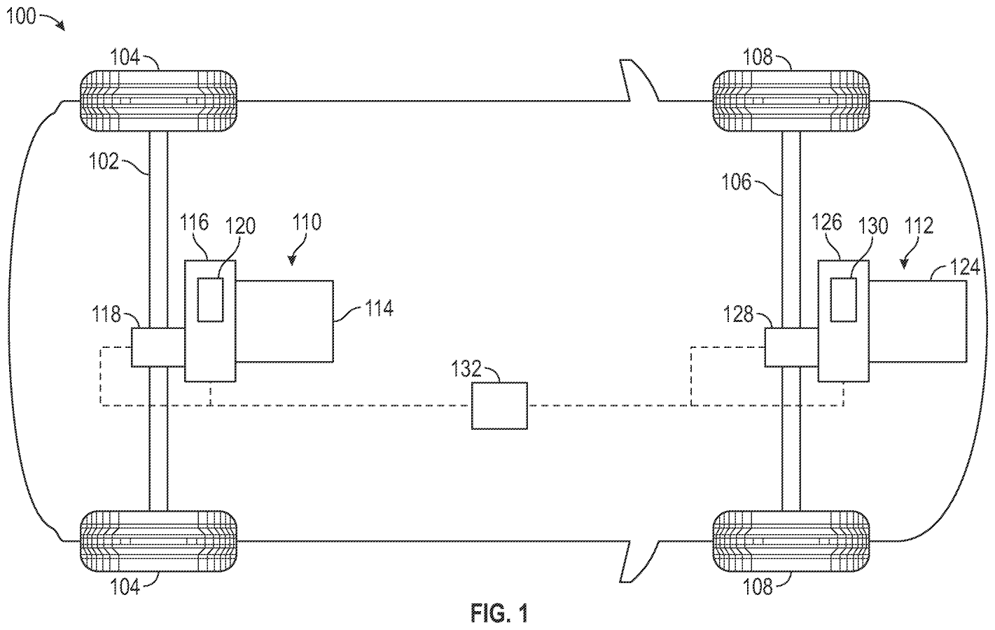

In accordance with an exemplary embodiment, FIG. 1 shows a schematic diagram of an electric vehicle 100 in a plan view. The electric vehicle (or battery electric vehicle) includes a first axle (rear axle 102) that connects rear tires 104 and a second axles (front axle 106) that connects front tires 108. A first drive system 110 provides power to the rear axle 102, and a second drive system 112 provides power to the front axle 106. The first drive system 110 can include a first battery (rear battery 114), first motor (rear motor 116), and first clutch (rear clutch 118). The rear motor 116 is an electric motor that converts power from the rear battery 114 into kinetic energy in the form of a rotation. The rear clutch 118 can engage the rear motor 116 to transfer the rotation from the rear motor to the rear axle 102 and rear tires 104. The rear motor 116 can include a first regenerative braking system 120. During braking, the first regenerative braking system 120 converts rotational energy of the rear axle 102 into electrical energy or current which is used to recharge the rear battery 114.

Similarly, the second drive system 112 can include a second battery (front battery 124), second motor (front motor 126), and second clutch (front clutch 128). The front motor 126 is an electric motor that converts power from the front battery 124 into kinetic energy in the form of a rotation. The front clutch 128 can engage the front motor 126 to transfer the rotation to the front axle 106 and front tires 108. The front motor 126 can include a second regenerative braking system 130. During braking, the second regenerative braking system 130 converts rotational energy of the front axle 106 into electrical energy or current which is used to recharge the front battery 124. In an embodiment, the second drive system 112 can be engaged when the vehicle is placed in an all-wheel drive mode and can be disengaged or shut down when not in the all-wheel drive mode.

While the electric vehicle 100 of FIG. 1 shows two drive systems, it is understood that there can be additional drive systems for different embodiments of the vehicle. In various applications, the rear axle can have multiple drive systems and/or the front axle can have multiple drive systems. Additionally, it is understood that the rear battery 114 and the front battery 124 can be replaced by a single battery that powers both the rear motor 116 and the front motor 126.

A controller 132 performs various operations to improve a range of the electric vehicle 100 and/or extend a lifetime of the batteries, as discussed herein. The controller 132 can distribute a torque load for the vehicle between rear motor and front motor to maximize efficiency. The controller 132 controls operation of the rear motor 116, the rear clutch 118, the front motor 126 and the front clutch 128. The speed of the one or more of the rear motor 116 and the front motor 126 can be regulated. Also, the rear clutch 118 and front clutch 128 can be operated to engage or disengage their respective motors to and from their respective axles.

The controller 132 may include processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality. The controller 132 may also include a non-transitory computer-readable medium that stores instructions which are processed by one or more processors of the controller to implement processes detailed herein.

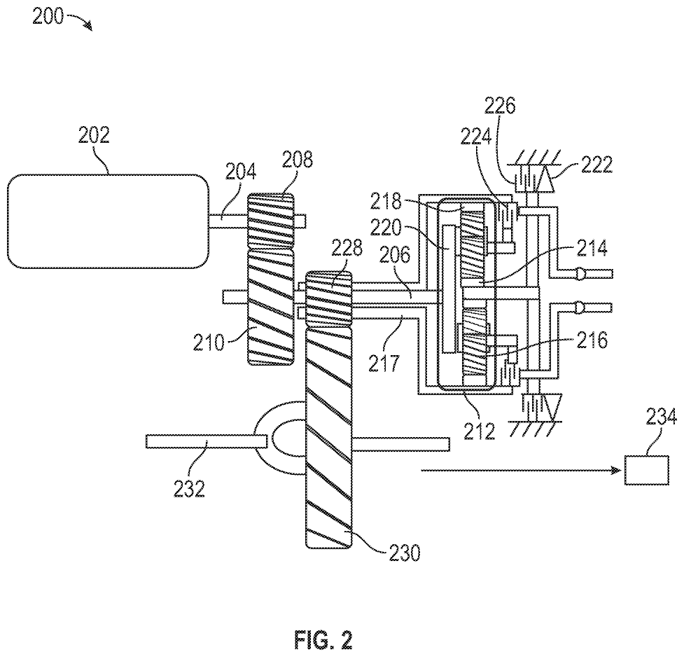

FIG. 2 shows a schematic view 200 of a drive system in an embodiment. A motor 202 rotates to creates a torque along a motor shaft 204. This torque can be transferred to a clutch shaft 206 by gears 208 and 210. The torque along the clutch shaft 206 produces a rotation at planetary gear set 212. As shown in FIG. 2, the planetary gear set 212 is a compound gear set including a sun gear 214, planetary gears 216, ring gear 218 and carrier 220. The ring gear 218 is coupled to a torque transfer component 217 that transfers torque from the ring gear 218 to a first drive gear 228. A first clutch 222, also referred to herein as a one-way clutch (OWC) controls a connection between the sun gear 214 and a ground or immobile state. The OWC can transfer torque in only one direction (a “positive” direction). For a rotation in the positive direction, if the speed of the motor 202 is reduced or brought to zero, the OWC can continue to rotate, thereby storing the rotational energy imparted to it by the motor. A second clutch 224 engages or disengages the ring gear 218 to the carrier 220 of the planetary gear set 212.

The planetary gear set 212 can operate to provide a first gear ratio and a second gear ratio for torque transfer. The first gear ratio is a non-unitary gear ratio (i.e., not a 1:1 ratio), while the second gear ratio is unitary (i.e., 1:1 ratio). For the first gear ratio, the sun gear 214 is locked to the OWC and the OWC is locked to ground. Torque from the motor 202 and clutch shaft 206 is transferred to the carrier 220 and then to the ring gear 218 via the planetary gears 216. The rotation of the ring gear 218 is then transferred to the first drive gear 228 via torque transfer component 217 to cause a rotation of the first drive gear 228. The torque is thus transferred to the drive shaft 232 via the first drive gear 228 and second drive gear 230. The torque along the drive shaft 232 is an output torque that is used to rotate an associated axle 234 at a selected axle speed.

In the second gear ratio, the second clutch 224 is engaged, locking the carrier 220 to the ring gear 218. The torque from the motor 202 is provided to the carrier 220 via the clutch shaft 206, from the carrier to the ring gear 218 and then to the first drive gear 228, second drive gear 230, drive shaft 232 and associated axle 234.

A third clutch 226 is in parallel with the first clutch 222 along the clutch shaft 206. The third clutch 226 can be locked to allow transfer of torque from the wheels of the vehicle to the motor 202 (in a “negative” direction). When both the second clutch 224 and the third clutch 226 are disengaged, the OWC can rotate with the associated axle 234 while the motor 202 is shut off.

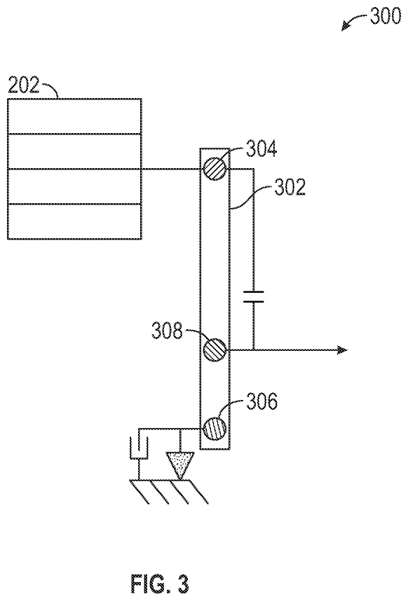

FIG. 3 is a diagram 300 illustrating speed relations between the various components of a drive system. Lever 302 corresponds to the layout of components in FIG. 2. The lever 302 indicates mathematically the relations between the speeds of the components of the drive system. A component is represented vertically along the lever 302 to indicate the spatial locations of the components with respect to each other. The speed is represented along a horizontal axis or x-axis of the diagram 300. Motor speed 304 represents the rotational speed of the motor 202. OWC speed 306 represents the rotational speed of the first clutch 222. The minimum speed possible for the first clutch 222 is zero. Output speed 308 represents a rotational speed that is sent to the axle associated with the motor 202. The output speed 308 is located at a point between the motor speed 304 and the OWC speed 306. As shown in FIG. 3, the OWC speed 306 is zero, indicating that the first clutch 222 is not rotating.

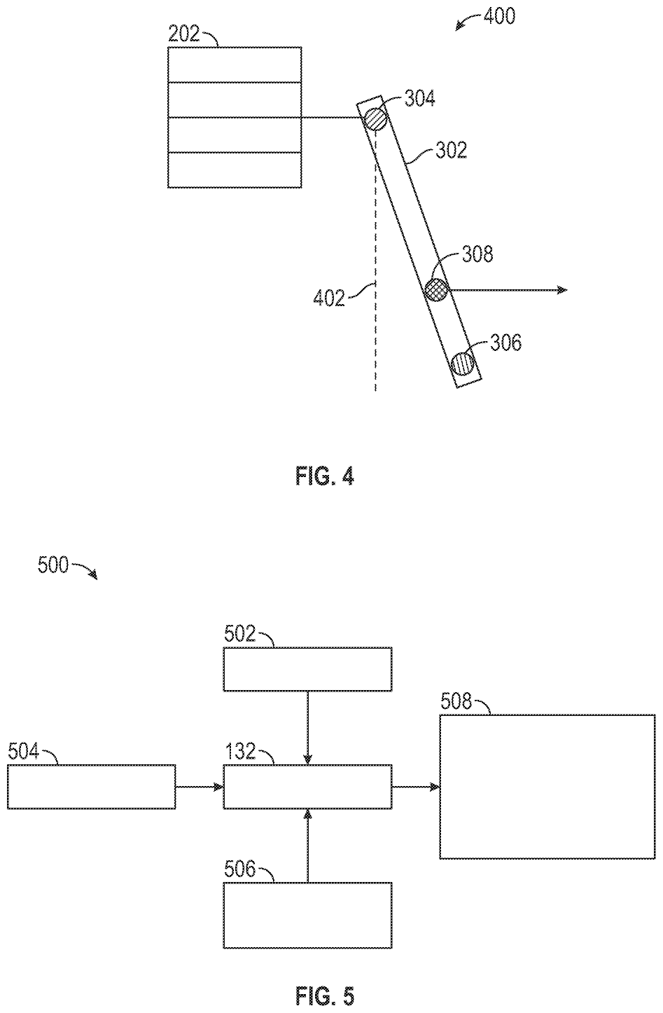

FIG. 4 is a diagram 400 illustrating speed relations in a scenario in which the vehicle is moving with an output speed 308 that is positive and the motor 202 is turned off. The motor speed 304 is shown along a zero-speed line 402. The OWC speed 306 is at a non-zero speed, as indicated by its horizontal distance from the zero-speed line 402. The output speed 308 can be determined from the motor speed 304, the OWC speed and 306 and the mathematical relation represented by lever 302.

FIG. 5 is a diagram 500 illustrating operation of the controller 132, in an embodiment. The controller 132 receives torque requirements or a torque load based on driver's input 502. The controller 132 also receives a vehicle speed 504 or axles speed from an appropriate sensor. The controller 132 also receives, or is in possession of, various limits and parameters 506 for the vehicle, such as total output torque limits, battery power limits, motor torque limits, and motor power coefficients. From these inputs, the controller 132 outputs various operational commands 508, such as an optimal motor torque for a motor, a command for controlling a distribution of torque load amongst the motors of the vehicle, a command to reduce a motor torque to zero, a command to disconnect a motor or place the drive system in a neutral state.

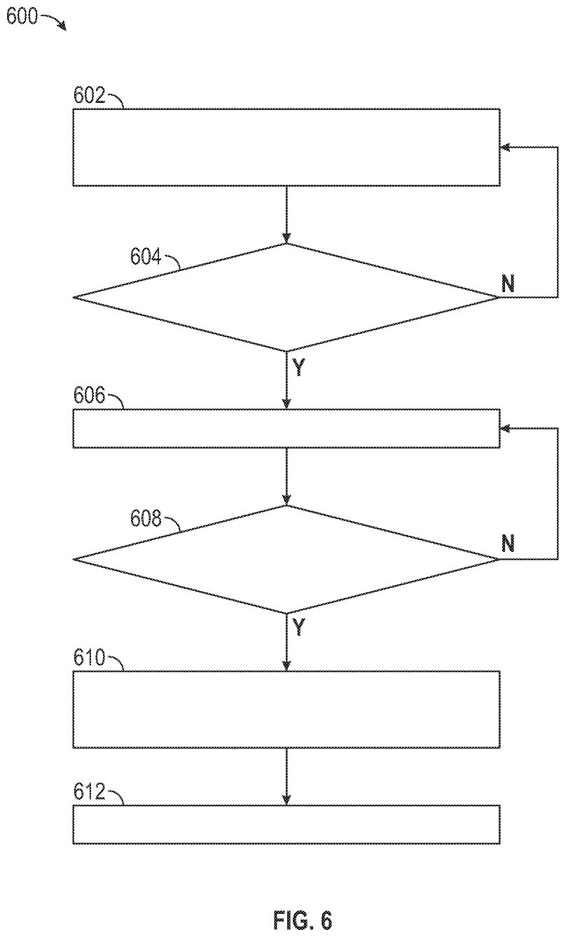

FIG. 6 shows a flowchart 600 of a method for disengaging a motor from an axle. In box 602, the electric vehicle 100 is operated in an energy optimization mode in which the total torque load for the vehicle is distributed between the available motor (e.g., the rear motor 116 and the front motor 126) according to a driver's input 502. In box 604, an optimization output is monitored during operation in a selected operation mode for a command to disengage a selected motor from a selected axle. The disengagement of an axle comes once zero torque is received from the corresponding motor. If a command has not been received, the method returns to box 604. If a command to disengage an axle has been received, the method proceeds to box 606.

In box 606, the torque load is shifted off of the selected motor to reduce its motor torque to zero. In box 608, the motor torque is monitored. If the motor torque is not zero, the method returns to box 606 in which additional torque load is shifted off of the selected motor. Returning to box 608, if the motor torque is zero, the method proceeds to box 610. In box 610, an engagement clutch (i.e., second clutch 224, third clutch 226) is determined based on the gear state or gear ratio (i.e., first gear, second gear, etc.). The engagement clutch is the clutch currently being used during the current operation mode. In box 612, the engagement clutch is disengaged.

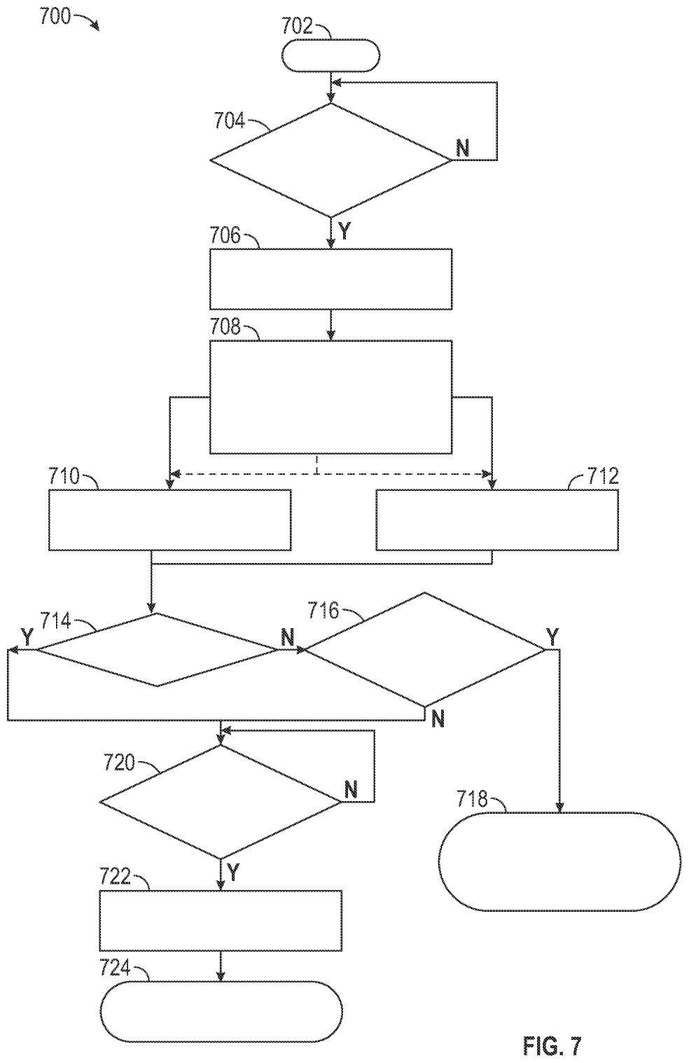

FIG. 7 shows a flowchart 700 of a method for engaging a disengaged motor to an axle. The method starts in box 702. In box 704, the optimization output of an optimization mode is monitored for a command to engage an axle. The method cycles through box 704 until such a command is received. Once the command is received, the method proceeds to box 706. In box 706, an optimal state for the gears and the motor speed for engagement is determined based on the current vehicle operating states such as vehicle speed and driver's input.

In box 708, a motor speed-up and synchronization strategy is selected. A first strategy includes using only the motor. A second strategy includes using only a clutch. A third strategy includes using both the motor and the clutch.

For the first strategy, the method proceeds from box 708 to box 710. In box 710, the motor is revved up until it reaches a motor speed that is synchronized with the speed of a component connected to a clutch that is to be engaged under the current vehicle speed. For the second strategy, the method proceeds from box 708 to box 712. In box 712, a torque from a relevant clutch (e.g., second clutch 224) is used to increase the rotation speed of any inertial devices mechanically connecting to the motor. For the third strategy, the method proceeds from box 708 to both box 710 and box 712. Either strategy synchronizes the motor speed to a clutch speed of the clutch.

Once the motor speed 304 and/or OWC speed 306 has been achieved, the method proceeds to box 714. In box 714, a signal is received to indicate whether regenerative braking is currently activated. If regenerative braking of the re-engagement motor is not to be activated, the method proceeds to box 716. In box 716, it is determined whether the OWC is engaged based on the speeds on both sides. The OWC is automatically engaged when the motor speed 304 is the same as the OWC speed 306. If the OWC is engaged, the method proceed to box 718. In box 718, the motor torque is controlled to achieve a desired torque at the axle. Returning to box 716, if the OWC is disengaged, the method proceeds to box 720. Similarly, if at box 714, the regenerative braking is to be activated, the method proceeds to box 720.

At box 720, the motor speed is adjusted until it is synchronized to provide a suitable output at the drive axle. Adjusting the motor speed can be based on the relation shown in FIGS. 3 and 4, for example. In box 722, the relevant clutch is closed. In box 724, the motor torque is applied to the axle to achieve a desired torque along the axle.

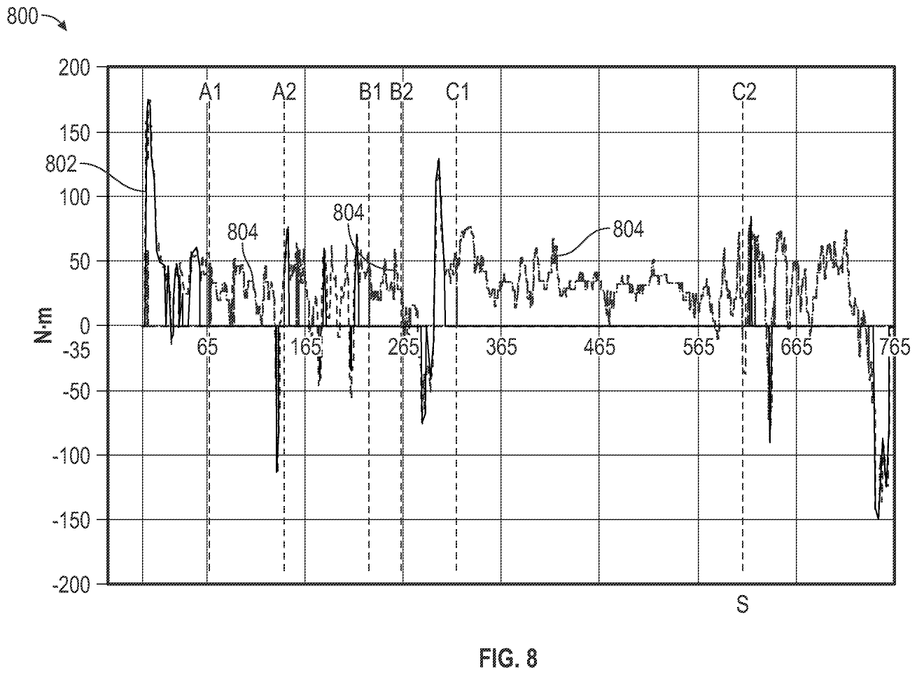

FIG. 8 shows a graph 800 illustrating torque distributions between the first motor and the second motor using the methods disclosed herein. Time is shown in seconds along the abscissa and torque is shown in Newton-meters (N-m) along the ordinate axis. The torque provided by the rear motor 116 is shown by first curve 802. The torque provided by the front motor 126 is shown by second curve 804. Prior to time A1, both the first motor and the second motor are providing torque to the vehicle. Between times A1 and A2, the first motor is turned off and the second motor is providing the torque to the vehicle. This is evident by seeing that only second curve 804 is present between time A1 and A2. Similarly, and as seen in FIG. 8, between times B1 and B2 and between times C1 and C2, the first motor is turned off and the second motor provides the torque to the vehicle.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed but will include all embodiments falling within the scope thereof.

What is claimed is:

1. A method for operating a battery electric vehicle having a first motor and a second motor, comprising:
selecting to disengage the first motor from a first axle;
adjusting a torque provided from the first motor to the first axle to zero;
disengaging the first motor from the first axle; and
reducing a speed of the first motor to zero.

2. The method of claim 1, wherein adjusting the torque from the first motor further comprises transferring a torque load of the first motor to at least the second motor.

3. The method of claim 1, further comprising identifying an engagement clutch associated with the first motor from a gear state associated with the first motor and disengaging the engagement clutch.

4. The method of claim 1, further comprising:
selecting to engage the first motor to the first axle;
determining the speed of the first motor;
synchronizing a clutch speed of a clutch with the speed of the first motor; and
engaging the clutch to connect the first motor to the first axle.

5. The method of claim 4, wherein synchronizing the clutch speed further comprising at least one of: (i) controlling a rotation of the first motor to a selected motor speed; and (ii) controlling a transfer torque of the clutch to rotate the first motor to the selected motor speed.

6. The method of claim 4, further comprising synchronizing the clutch speed to a selected motor speed by controlling at least one of the first motor and the clutch during regenerative braking at the first motor.

7. The method of claim 1, wherein reducing the speed of the first motor to zero recovers rotational energy.

8. A system for operating an electric vehicle having a first motor and a second motor, comprising:
a processor configured to:
select the first motor for disengagement from a first axle;
adjust a torque provided from the first motor to the first axle to zero;
disengage the first motor from the first axle; and
reduce a speed of the first motor to zero.

9. The system of claim 8, wherein the processor is further configured to adjust the torque from the first motor to zero by transferring a torque load of the first motor to at least the second motor.

10. The system of claim 8, wherein the processor is further configured to identify an engagement clutch associated with the first motor from a gear state associated with the first motor and disengage the engagement clutch.

11. The system of claim 8, wherein the processor is further configured to:
select the first motor for engagement to the first axle;
determine the speed of the first motor;
synchronize a clutch speed of a clutch with the speed of the first motor; and
engage the clutch to connect the first motor to the first axle.

12. The system of claim 11, wherein synchronizing the clutch speed further comprises at least one of: (i) controlling a rotation of the first motor to a selected motor speed; and (ii) controlling a transfer torque of the clutch to rotate the first motor to the selected motor speed.

13. The system of claim 11, wherein the processor is further configured to synchronize the clutch speed to an axle speed by controlling at least one of the first motor and the clutch during regenerative braking at the first motor.

14. The system of claim 8, wherein reducing the speed of the first motor to zero recovers rotational energy.

15. An electric vehicle, comprising:
a first motor;
a second motor; and
a processor configured to:
select the first motor for disengagement from a first axle;
adjust a torque provided from the first motor to the first axle to zero;
disengage the first motor from the first axle; and
reduce a speed of the first motor to zero.

16. The electric vehicle of claim 15, wherein the processor is further configured to adjust the torque from the first motor to zero by transferring a torque load of the first motor to at least the second motor.

17. The electric vehicle of claim 15, wherein the processor is further configured to identify an engagement clutch associated with the first motor from a gear state associated with the first motor and disengaging the engagement clutch.

18. The electric vehicle of claim 15, wherein the processor is further configured to:
select to engage the first motor to the first axle;
determine the speed of the first motor;
synchronize a clutch speed of a clutch with the speed of the first motor; and
engage the clutch to connect the first motor to the first axle.

19. The electric vehicle of claim 18, wherein synchronizing the clutch speed further comprises at least one of: (i) controlling a rotation of the first motor to a selected motor speed; and (ii) controlling a transfer torque of the clutch to rotate the first motor to the selected motor speed.

20. The electric vehicle of claim 18, wherein the processor is further configured to synchronize the clutch speed to an axle speed by controlling at least one of the first motor and the clutch during regenerative braking at the first motor.
